(19) United States
(12) Patent Application Publication
(10) Pub. No.: US 2024/0054529 A1
(43) Pub. Date: Feb. 15, 2024

(54) Incentive-Based Advertising for a Unique Verified Individual

(71) Applicant: FairAdsAPP, Inc., Round Rock, TX (US)

(72) Inventor: Constantin Florin Murariu, Round Rock, TX (US)

(73) Assignee: FairAdsAPP, Inc., Round Rock, TX (US)

(21) Appl. No.: 18/208,300

(22) Filed: Jun. 11, 2023

Related U.S. Application Data
(60) Provisional application No. 63/396,931, filed on Aug. 10, 2022.

(51) Int. Cl. G06Q 30/0251; G06Q 30/0207

(52) U.S. Cl. CPC G06Q 30/0258; G06Q 30/0255; G06Q 30/0215

(57) ABSTRACT

A computer system may obtain information specifying a unique verified individual. Then, the computer system may determine an interest of the unique verified individual and may provide, addressed to an electronic device associated with the unique verified individual, an advertisement based at least in part on the determined interest, where the advertisement is intended for the unique verified individual, and the advertisement is associated with a provider of a product or a service. Next, the computer system may receive, from the electronic device or a computer, a response associated with the advertisement. When the response indicates the electronic device accessed a location associated with the provider of the product or the service, accepted an offer associated with the provider of the product or the service, or purchased the product or the service, the computer system may provide a credit to an account associated with the unique verified individual.

### CROSS REFERENCE TO RELATED APPLICATIONS

This application claims priority under 35 U.S.C. 119(e) to U.S. Provisional Application Ser. No. 63/396,931, entitled “Incentive-Based Advertising for a Unique Verified Individual,” by Constantin Florin Murariu, filed on Aug. 10, 2022, the contents of both of which are herein incorporated by reference.

### FIELD

The described embodiments relate to techniques for providing incentive-based advertising to a unique verified individual.

### BACKGROUND

Digital advertising that is provided via networks, such as the Internet or World Wide Web (WWW), has become a large source of revenue for companies. Moreover, behaviors or activities of individuals are routinely used to subsequently target advertising to the individuals. For example, information about the web pages or websites visited by an individual, online purchases by the individual (or e-commerce), and physical locations of an electronic device of the individual provide a digital signature of the individual that can be used to dynamically target digital advertising to the individual (such as in advertising embedded in a window in a web page).

However, the targeting of advertisements in existing digital advertising approaches is often hindered by uncertainty in the digital signatures, such as whether or not a monitored activity or behavior is actually associated with a particular individual. Instead, digital signatures typically include information that is probabilistically associated with individuals, which means that targeted advertising is often provided in error and, thus, may be ineffective. Such mistargeted advertisements increase costs for advertisers. These challenges have been compounded by the removal of cookie-based tracking and the use of dynamic network addresses (such as randomization of a media access control or MAC address of an electronic device), which have increased the association uncertainty in digital signatures.

Furthermore, even when a targeted advertisement is provided to the correct individual at an opportune time, it can be difficult to accurately assess the impact of the targeted advertisement. Notably, it is often challenging to determine whether subsequent purchasing behavior by the individual was, in fact, in response to or motivated by the targeted advertisement. This attribution problem increases errors in the targeting of advertisements, and thus can also increase costs for advertisers.

### SUMMARY

A computer system that selectively provides a credit described. This computer system includes: an interface circuit; a computation device coupled to the interface circuit; and memory, coupled to the computation device, storing program instructions. During operation, the computer system obtains information specifying a unique verified individual. Then, the computer system determines an interest of the unique verified individual. Moreover, the computer system provides, addressed to an electronic device associated with the unique verified individual, an advertisement based at least in part on the determined interest, where the advertisement is intended for the unique verified individual, and the advertisement is associated with a provider of a product or a service. Next, the computer system receives, associated with the electronic device or a computer, a response associated with the advertisement. Furthermore, when the response indicates the electronic device accessed a location associated with the provider of the product or the service, accepted an offer associated with the provider of the product or the service, or purchased the product or the service, the computer system provides the credit to an account associated with the unique verified individual.

Note that an identity of the unique verified individual, while unknown to the computer system, may be confirmed and may not be associated with another individual.

Moreover, the obtaining may include receiving, associated with the electronic device, the information.

Furthermore, the determining may include receiving, associated with a second computer, second information specifying or corresponding to the interest of the unique verified individual. Alternatively or additionally, the determining may include receiving, associated with the electronic device, the second information. In some embodiments, the second information may be based at least in part on selections from predefined categories of interests. Note that the second information may be based at least in part on behaviors or activities of the unique verified individual, e.g., when using the electronic device.

Moreover, the advertisement may be provided based at least in part on advertisement parameters associated with the provider of the product or the service.

Furthermore, the computer may be associated with the provider of the product or the service.

Additionally, the location may include a web page or a website.

In some embodiments, the credit may include a cryptographic token or may be associated with another type of financial instrument.

Note that the account may include a digital wallet associated with the unique verified individual.

Moreover, an identity of the unique verified individual may remain unknown to the computer system during operations performed by the computer system.

Furthermore, the response may include or may correspond to proof of purchase of the product or the service.

Additionally, the credit may include a portion of a financial value of the advertisement.

Another embodiment provides the electronic device, which performs counterpart operations to at least some of the aforementioned operations.

Another embodiment provides the computer, which performs counterpart operations to at least some of the aforementioned operations.

Another embodiment provides a computer-readable storage medium for use with the computer system, the electronic device or the computer. When executed by the computer system, the electronic device or the computer, this computer-readable storage medium causes the computer system, the electronic device or the computer to perform at least some of the aforementioned operations or counterparts to at least some of the aforementioned operations.

Another embodiment provides a method, which may be performed by the computer system, the electronic device or the computer. This method includes at least some of the aforementioned operations or counterparts to at least some of the aforementioned operations.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

FIG. 1 is a block diagram illustrating communication among electronic devices and a computer system in accordance with an embodiment of the present disclosure.

FIG. 2 is a flow diagram illustrating a method for selectively providing a credit in accordance with an embodiment of the present disclosure.

FIG. 3 is a drawing illustrating communication among the electronic devices and the computer systems in FIG. 1 in accordance with an embodiment of the present disclosure.

FIG. 4 is a block diagram illustrating an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

During operation, a computer system may obtain information specifying a unique verified individual. Then, the computer system may determine an interest of the unique verified individual. Moreover, the computer system may provide, addressed to an electronic device associated with the unique verified individual, an advertisement based at least in part on the determined interest, where the advertisement is intended for the unique verified individual, and the advertisement is associated with a provider of a product or a service. Next, the computer system may receive, associated with the electronic device or a computer, a response associated with the advertisement. Furthermore, when the response indicates the electronic device accessed a location associated with the provider of the product or the service, accepted an offer associated with the provider of the product or the service, or purchased the product or the service, the computer system may provide a credit to an account associated with the unique verified individual.

By providing the advertisement to the unique verified individual and selectively providing the credit, these advertising techniques may allow advertising to be accurately targeted and may incentivize participation of the individual in the advertising techniques. Notably, by sharing a portion of the revenue associated with successful advertising as a credit to the individual, the advertising techniques may incentivize the individual to enroll in the advertising technique, and thus to provide or to authorize the providing of the information. Moreover, the advertising techniques may allow the unique verified individual to remain anonymous to the computer system, thereby protecting the individual's privacy while allowing the individual to benefit from the targeted advertisement. Consequently, the advertising techniques may significantly increase the accuracy of targeted advertising, may reduce costs of advertisers (such as the provider of the service or the product) by reducing or eliminated mistargeted advertisements, and/or may reduce or eliminate the attribution problem. Therefore, the advertising techniques may increase the satisfaction or the user experience of the individual and advertisers, such as the provider of the service or the product.

In the discussion that follows, an individual or a user of the advertising techniques may be a person. Also, or instead, the advertising techniques may be used by any type of organization, such as a business (which should be understood to include for-profit corporations), non-profit corporations, groups (or cohorts) of individuals, sole proprietorships, government agencies, partnerships, etc.

In the discussion that follows, electronic devices or components in a system communicate packets in accordance with a wireless communication protocol, such as: a wireless communication protocol that is compatible with an IEEE 802.11 standard (which is sometimes referred to as ‘Wi-Fi,’ from the Wi-Fi Alliance of Austin, Texas), Bluetooth or Bluetooth low energy or BLE (from the Bluetooth Special Interest Group of Kirkland, Washington), a cellular-telephone network or data network communication protocol (such as a third generation or 3G communication protocol, a fourth generation or 4G communication protocol, e.g., Long Term Evolution or LTE (from the 3rd Generation Partnership Project of Sophia Antipolis, Valbonne, France), LTE Advanced or LTE-A, a fifth generation or 5G communication protocol, or other present or future developed advanced cellular communication protocol), and/or another type of wireless interface (such as another wireless-local-area-network interface). For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. Moreover, an access point, a radio node, a base station or a switch in the wireless network may communicate with a local or remotely located computer or computer system using a wired communication protocol, such as a wired communication protocol that is compatible with an IEEE 802.3 standard (which is sometimes referred to as ‘Ethernet’), e.g., an Ethernet II standard and/or another type of wired interface. However, a wide variety of communication protocols may be used in the system, including wired and/or wireless communication. In the discussion that follows, Wi-Fi and Ethernet are used as illustrative examples.

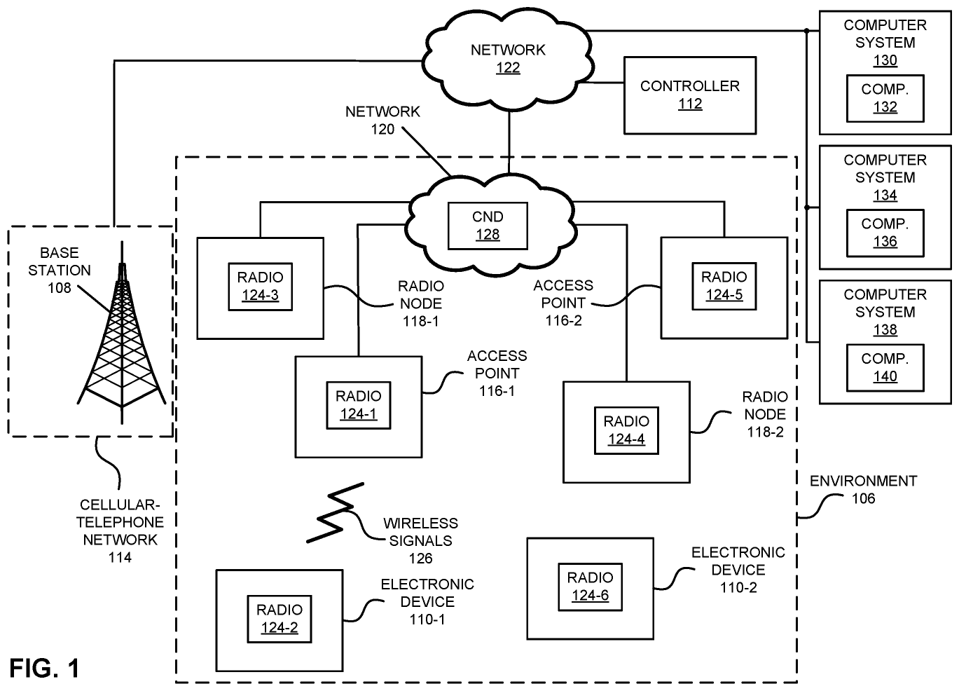

We now describe some embodiments of the disclosed techniques. FIG. 1 presents a block diagram illustrating an example of communication in an environment 106 with one or more electronic devices 110 (such as cellular telephones, portable electronic devices, stations or clients, another type of electronic device, etc., which are sometimes referred to as ‘end devices’) via a cellular-telephone network 114 (which may include a base station 108), one or more access points 116 (which may communicate using Wi-Fi) in a wireless local area network (WLAN) and/or one or more radio nodes 118 (which may communicate using LTE or a 5G cellular-telephone communication protocol) in a network (such as a small cell). For example, the one or more radio nodes 118 may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc. In the discussion that follows, an access point, a radio node or a base station are sometimes referred to generically as a ‘communication device.’ Moreover, one or more base stations (such as base station 108), access points 116, and/or radio nodes 118 may be included in one or more wireless networks, such as: a WLAN, a small cell, and/or a cellular-telephone network. In some embodiments, access points 116 may include a physical access point and/or a virtual access point that is implemented in software in an environment of an electronic device or a computer.

Note that access points 116 and/or radio nodes 118 may communicate with each other, a computer system 130 and/or an optional controller 112 (which may be a local or a cloud-based controller that manages and/or configures access points 116, radio nodes 118 and/or a computer network device or CND 128, such as a switch or a router) using a wired communication protocol (such as Ethernet) via network 120 and/or 122. Moreover, computer system 130 may include one or more computers 132. However, in some embodiments, access points 116 and/or radio nodes 118 may communicate with each other and/or the controller using wireless communication (such as Wi-Fi, Bluetooth and/or another wireless communication protocols), e.g., one of access points 116 may be a mesh access point in a mesh network. Note that networks 120 and 122 may be the same or different networks. For example, networks 120 and/or 122 may an LAN, an intra-net or the Internet. In some embodiments, wireless communication between at least pairs of components in FIG. 1 involves the use of dedicated connections, such as via a peer-to-peer (P2P) communication technique.

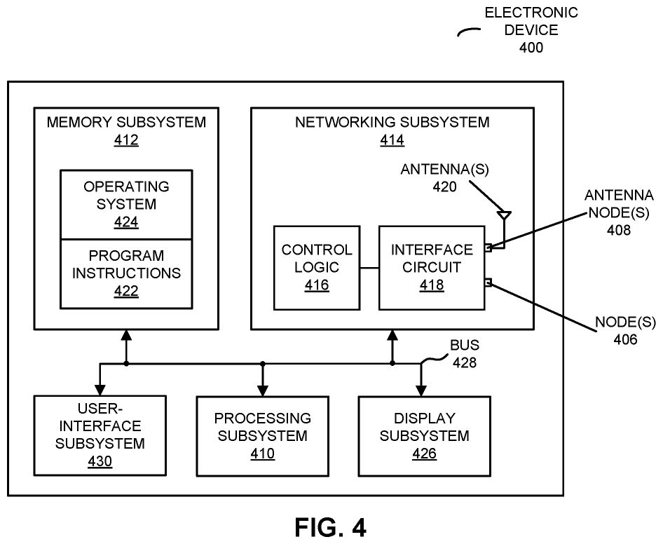

As described further below with reference to FIG. 4, electronic devices 110, controller 112, access points 116, radio nodes 118, computer network device 128, and computer system 130 may include subsystems, such as a networking subsystem, a memory subsystem and a processor subsystem. In addition, electronic devices 110, access points 116 and radio nodes 118 may include radios 124 in the networking subsystems. More generally, electronic devices 110, access points 116 and radio nodes 118 can include (or can be included within) any electronic devices with the networking subsystems that enable electronic devices 110, access points 116 and radio nodes 118 to wirelessly communicate with one or more other electronic devices. This wireless communication can comprise transmitting access on wireless channels to enable electronic devices to make initial contact with or detect each other, followed by exchanging subsequent data or management frames (such as connection requests and responses) to establish a connection, configure security options, transmit and receive frames or packets via the connection, etc.

During the communication in FIG. 1, access points 116 and/or radio nodes 118 and electronic devices 110 may wired or wirelessly communicate while: transmitting access requests and receiving access responses on wireless channels, detecting one another by scanning wireless channels, establishing connections (for example, by transmitting connection requests and receiving connection responses), and/or transmitting and receiving frames or packets (which may include information as payloads).

As can be seen in FIG. 1, wireless signals 126 (represented by a jagged line) may be transmitted by radios 124 in, e.g., access points 116 and/or radio nodes 118 and electronic devices 110. For example, radio 124-1 in access point 116-1 may transmit information (such as one or more packets or frames) using wireless signals 126. These wireless signals are received by radios 124 in one or more other electronic devices (such as radio 124-2 in electronic device 110-1). This may allow access point 116-1 to communicate information to other access points 116 and/or electronic device 110-1. Note that wireless signals 126 may convey one or more packets or frames.

In the described embodiments, processing a packet or a frame in access points 116 and/or radio nodes 118 and electronic devices 110 may include: receiving the wireless signals with the packet or the frame; decoding/extracting the packet or the frame from the received wireless signals to acquire the packet or the frame; and processing the packet or the frame to determine information contained in the payload of the packet or the frame.

Note that the wireless communication in FIG. 1 may be characterized by a variety of performance metrics, such as: a data rate for successful communication (which is sometimes referred to as ‘throughput’), an error rate (such as a retry or resend rate), a mean-squared error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 124 are shown in components in FIG. 1, one or more of these instances may be different from the other instances of radios 124.

In some embodiments, wireless communication between components in FIG. 1 uses one or more bands of frequencies, such as: 900 MHz, 2.4 GHz, 5 GHz, 6 GHz, 7 GHz, 60 GHz, the Citizens Broadband Radio Spectrum or CBRS (e.g., a frequency band near 3.5 GHz), and/or a band of frequencies used by LTE or another cellular-telephone communication protocol or a data communication protocol. Note that the communication between electronic devices may use multi-user transmission (such as orthogonal frequency division multiple access or OFDMA) and/or multiple-input multiple-output (MIMO).

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

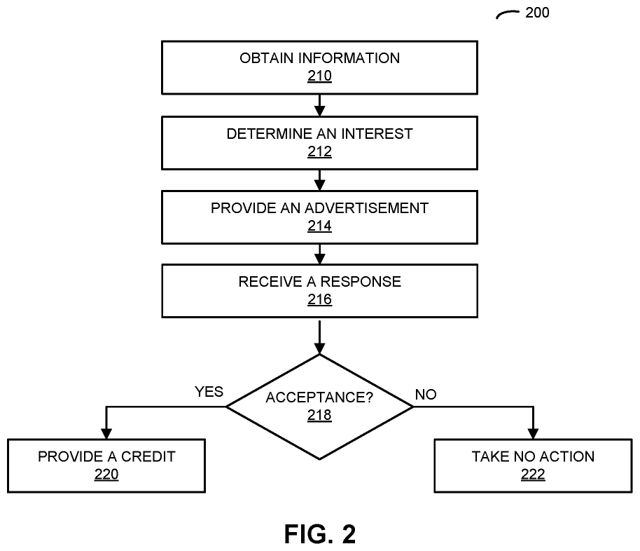

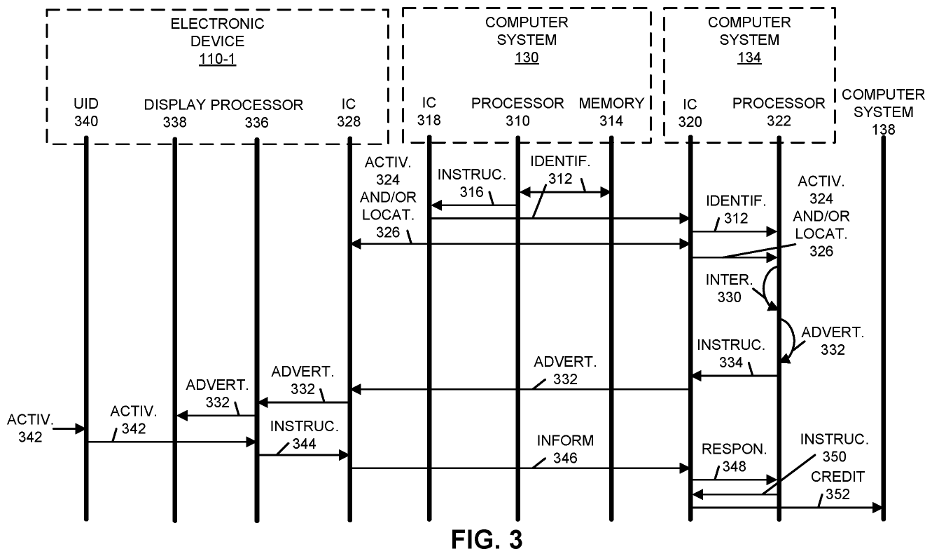

As discussed previously, it can be difficult to target advertisements to individuals. Moreover, as discussed below with reference to FIGS. 2 and 3, these problems may be addressed using the advertising techniques. Notably, an individual, such as a user of an electronic device (such as electronic device 110-1, e.g., a cellular telephone, a computer, etc.), may opt into the advertising techniques. For example, the individual may establish a profile on computer system 130 that uniquely verifies the individual to a third party, while keeping the identity of individual anonymous to the third party. Note that the profile of the individual may be associated with a blockchain or a distributed ledger.

In some embodiments, the profile may be established using a registration process, which may be performed by the individual using electronic device 110-1 and by interacting with computer system 130 (or a computer) that establishes the profile of the individual. For example, the registration process may include a know your customer (KYC) process or verification service in which the individual provides identifying information, such as an image of their driver's license, a Social Security number, etc. to the computer system 130.

In addition to registering the individual, during the registration process the individual may provide, to computer system 130, information about the interests of the individual, such as activities, products or services the individual likes or dislikes. For example, the individual may select their interests from predefined categories of interests using a user interface (e.g., which may be provided by computer system 130 and rendered in a Browser on electronic device 110-1, using an application associated with computer system 130 and installed on electronic device 110-1, and/or by interaction with a web page or website associated with computer system 130). Alternatively or additionally, the information about the interests of the individual may be indirectly provided or specified, such as by having the individual select or provide socio-demographic information (e.g., age, gender, income, marital status, etc.), address information, academic information, professional information (e.g., a type of job of the individual), hobbies, activities, behaviors and/or another type of information that corresponds to the interests of the individual.

Moreover, during the registration process, the individual may provide or specify a financial account of or associated with the individual. For example, the financial account may be associated with a digital currency, such as a digital wallet of the individual that is based on a digital representation of a physical currency or a cryptographic token (such as cryptographic currency based on blockchain, e.g., a decentralized anonymous organization (DAO) token). However, in general, the financial account of the individual may be based on another type of financial instrument, such as a credit card or a debit card, or another type of incentive or reward.

As noted previously, in some embodiments the registration process may be performed via: a web page or a website that the individual navigates to, a browser plugin, or an application that is installed on and that executes in an environment of electronic device 110-1 (such as the operating system).

After the registration process, the individual (who is sometimes referred to as a ‘unique verified individual’) may provide to computer system 130 or authorize computer system 130 to provide information specifying them as the unique verified individual in the profile. For example, the unique verified individual may instruct electronic device 110-1 to provide the information to computer system 130 or an optional computer system 134 (which includes one or more computers 136) that implements the advertising techniques, which may be the same as or different from computer system 130 that establishes the profile of the unique verified individual. In the discussion that follows, the advertising technique is illustrated using computer system 134. In some embodiments, the unique verified individual is identified by a unique identifier that is generated using a secure or cryptographic (one-way) hash from an identifier of the unique verified individual (and/or an identifier of electronic device 110-1, which is used by the unique verified individual). Alternatively or additionally, the unique verified individual may be identified using blockchain, which uniquely identifies the individual while maintaining their anonymity.

Then, computer system 134 may determine an interest of the unique verified individual. For example, the determining may include receiving, associated with computer system 130, second information specifying or corresponding to the interest of the unique verified individual (such as an interest that was specified by the individual during the enrollment process). Alternatively or additionally, the determining may include receiving, associated with electronic device 110-1, the second information (such as by having the unique verified individual directly provide the second information to computer system 134, instead of via computer system 130). As noted previously, in some embodiments, the second information may be based at least in part on selections by the unique verified individual from predefined categories of interests. Note that the second information may be based at least in part on behaviors or activities of the unique verified individual, e.g., when using electronic device 110-1 (such as when navigating to and viewing web pages or websites, performing e-commerce, etc.). Thus, in some embodiments, the second information may be dynamically determined by computer system 134 based at least in part on actions and/or activities of the unique verified individual.

Moreover, computer system 134 may provide, addressed to electronic device 110-1, an advertisement based at least in part on the determined interest, where the advertisement is intended for the unique verified individual, and the advertisement is associated with a provider of a product or a service (which is sometimes referred to as an ‘advertiser’). Note that the advertisement may be provided based at least in part on advertisement parameters associated with the provider of the product or the service. For example, the provider of the product or the service may have previously provided the advertising parameters to computer system 134 via another computer or another computer system (not shown). In some embodiments, computer system 134 indirectly provides the advertisement to electronic device 110-1, e.g., via a demand site provider (not shown) that brokers advertising.

Next, computer system 134 may receive, associated with electronic device 110-1 or a computer (not shown) (which may or may not be included in computer system 130 or computer system 134, e.g., which may be associated with a party that is different from a provider of the advertising techniques, such as a retailer or the provider of the product or the service), a response associated with the advertisement. For example, the unique verified individual may, via electronic device 110-1, provide the response that includes or corresponds to proof of purchase of the product or the service, such as a receipt or an image of a receipt for the product or the service.

Furthermore, when the response indicates electronic device 110-1 accessed a location (such as a web page or a website) associated with the provider of the product or the service, accepted an offer associated with the provider of the product or the service, or purchased the product or the service, computer system 134 may provide a credit to the account associated with the unique verified individual (such as to an account managed by computer system 138, which includes one or more computers 140). For example, the credit may include a financial incentive to the unique verified individual, such as a portion of the revenue associated with the advertisement, which may be paid by the provider of the product or the service to a provider of computer system 134 or the advertising techniques. Thus, the credit may include a portion of a financial value of the advertisement, such as 51% of the financial value.

In some embodiments, there may be different tiers or categories of credit that are provided to the account. For example, there may be different rewards for an impression or viewing of the advertisement by the unique verified individual, clicking through or activating a link associated with the advertisement, and conversion, such as downloading or purchasing the product or the service.

In these ways, the advertising techniques may incentivize the unique verified individual to participate, thereby improving the accuracy of targeted advertising, such as the advertisement. Moreover, the advertising techniques may also allow the unique verified individual to maintain their privacy. Notably, computer system 134 may not know the identity of the unique verified individual during the advertising technique (thus, the identity of the unique verified individual may be obfuscated). However, computer system 134 may be able to confirm that the unique verified individual is not another individual (and, thus, that the individual is the unique verified individual), which may allow information about the unique verified individual to be collected or aggregated, so that advertising can be accurately targeted to the unique verified individual. Furthermore, by selectively providing the credit after the efficacy of the advertisement has been confirmed, the advertising techniques may address the attribution problem, thereby further improving the accuracy of targeted advertising by closing the loop and confirming whether a give targeted advertisement was effective in modifying the activity or the behavior of the unique verified individual.

Note that by improving the targeting of advertising, the advertising techniques may reduce the use of resources in computer system 134, such as processing, memory, network bandwidth, etc. For example, the advertising techniques may reduce mistargeted advertisements. Thus, the advertising techniques may improve the efficiency of computer system 134.

While FIG. 1 illustrates computer system 130 and computer system 134 performing at least some of the operations in the advertising techniques, in other embodiments one or more of the operations performed by computer system 130 and/or computer system 134 in the advertising techniques may be performed by another component in FIG. 1, such as electronic device 110-1. Thus, in general, one or more operations in the techniques may be implemented in a centralized or a distributed manner.

We now describe embodiments of methods associated with the advertising techniques. FIG. 2 presents a flow diagram illustrating an example of a method 200 for selectively providing a credit, which may be performed by a computer system (such as computer system 134 in FIG. 1). During operation, the computer system may obtain information (operation 210) specifying a unique verified individual. Note that an identity of the unique verified individual, while unknown to the computer system, may be confirmed and may not be associated with another individual. Moreover, the obtaining may include receiving, associated with an electronic device associated with the unique verified individual (such as a cellular telephone or a computer used by the unique verified individual), the information.

Then, the computer system may determine an interest (operation 212) of the unique verified individual. For example, the determining may include receiving, associated with a second computer, second information specifying or corresponding to the interest of the unique verified individual. Alternatively or additionally, the determining may include receiving, associated with the electronic device, the second information. In some embodiments, the second information may be based at least in part on selections from predefined categories of interests. Note that the second information may be based at least in part on behaviors and/or activities of the unique verified individual, e.g., when using the electronic device (such as navigation to and/or interaction with one or more web pages or websites, a location of the electronic device, etc.).

Moreover, the computer system may provide, addressed to the electronic device, an advertisement (operation 214) based at least in part on the determined interest, where the advertisement is intended for the unique verified individual, and the advertisement is associated with a provider of a product or a service. For example, one or more attributes or characteristics associated with the advertisement may match one or more attributes or characteristics of the determined interest. Notably, the one or more attributes or characteristics of the determined interest may be input to a pretrained predictive model (such as a supervised machine-learning model, e.g., the supervised machine-learning model may have been obtained from a training dataset using a support vector machine technique, a classification and regression tree technique, logistic regression, LASSO, linear regression, a neural network technique, e.g., a convolutional neural network technique, a generative adversarial network or another type of neural network technique, and/or another linear or nonlinear supervised machine-learning technique), which outputs or selects the advertisement. Thus, the advertisement may be dynamically generated for the unique verified individual or may be a predefined or predetermined advertisement that is selected for the unique verified individual. Note that the advertisement may be provided based at least in part on advertisement parameters associated with the provider of the product or the service. In some embodiments, providing the advertisement (operation 214) may include providing a pointer or a location (such as a server) that provides the advertisement.

Next, the computer system may receive, associated with the electronic device or a second computer, a response (operation 216) associated with the advertisement. For example, the response may indicate activation of a link included in the advertisement. In some embodiments, the response may include or may correspond to proof of purchase of the product or the service. Note that the second computer may be associated with the provider of the product or the service.

Furthermore, when the response indicates acceptance of an offer associated with the product or the service (operation 218), such as when the electronic device accessed a location (such as a location of a web page or a website, e.g., an Internet Protocol address, a Uniform Resource Locator or URL, or a Uniform Resource Indicator or URI) associated with the provider of the product or the service, accepted an offer associated with the provider of the product or the service, or purchased the product or the service, the computer system may provide the credit (operation 220) to an account associated with the unique verified individual. Otherwise (operation 218), the computer system may not take an action (operation 222).

In some embodiments, the credit may include a cryptographic token or may be associated with another type of financial instrument. Additionally, the credit may include a portion of a financial value of the advertisement. Note that the account may include a digital wallet associated with the unique verified individual.

Moreover, an identity of the unique verified individual may remain unknown to the computer system at least during operations performed by the computer system or globally (e.g., the computer system may never know the identity of the unique verified individual).

In some embodiments of method 200, there may be additional or fewer operations. Furthermore, the order of the operations may be changed, and/or two or more operations may be combined into a single operation.

Embodiments of the advertising techniques are further illustrated in FIG. 3, which presents a drawing illustrating an example of communication among electronic device 110-1, computer system 130, computer system 134 and computer system 138. Notably, a processor 310 in computer system 130 may access an identifier 312 of a unique verified individual in memory 314 in computer system 130. Then, processor 310 may instruct 316 an interface circuit 318 in computer system 130 to provide identifier 312 to computer system 134. For example, identifier 312 may include: an identifier of electronic device 110-1 (such as a MAC address), an identifier of the unique verified individual (such as a token), etc. After receiving identifier 312, an interface circuit 320 in computer system 134 may provide identifier 312 to a processor 322 in computer system 134.

Moreover, interface circuit 320 may monitor activity 324 and/or location 326 of electronic device 110-1 by interacting with interface circuit 328 in electronic device 110-1. For example, activity 324 may include navigation and/or interaction with a web page or a website by the unique verified individual. Alternatively or additionally, location 326 may include a physical location of electronic device 110-1, such as Global Positioning System or GPS coordinates, a location determined by triangulation and/or trilateration, etc. Interface circuit 320 may provide activity 324 and/or location 326 to processor 322.

Then, processor 322 (or a computation device) may determine an interest 330 of the unique verified individual. For example, activity 324 and/or location 326 may be input to a pretrained predictive model (such as a supervised machine-learning model) that is executed by processor 322, and interest 330 may be output by the pretrained predictive model.

Moreover, processor 322 may compute or dynamically generate advertisement 332 based at least in part on interest 330. For example, interest 330 may be input to a second pretrained predictive model (such as a second supervised machine-learning model), and advertisement 332 may be output by the second pretrained predictive model. Alternatively, advertisement 332 may be output or selected from a set of predefined advertisements based at least in part on interest 330. Notably, processor 322 may rank the predefined advertisements based at least in part on matches between one or more attributes or characteristics of the predefined advertisements and one or more attributes or characteristics associated with interest 330.

Next, processor 322 may instruct 334 interface circuit 320 to provide to electronic device 110-1 with advertisement 332 (or information specifying advertisement 332). This advertisement may be intended for the unique verified individual, and advertisement 332 may be associated with a provider of a product or a service.

After receiving advertisement 332, interface circuit 328 may provide advertisement 332 to processor 336 in electronic device 110-1. Moreover, processor 336 may display advertisement 332 on a display 338 (and//or may output audio associated with advertisement 332 using one or more speakers) in or associated with electronic device 110-1. Then, the unique verified individual may accept advertisement 332, e.g., by activating 342 a link in or associated with advertisement 332 using a user-interface device (UID) 340 (such as a touch-sensitive display) in electronic device 110-1. In response to activating 342 the link, processor 336 may instruct 344 interface circuit 328 to inform 346 computer system 134 (or a computer system that is associated with the provider of the product or the service, and which may inform computer system 134 that advertisement 332 was accepted).

After receiving the information, interface circuit 320 may provide an associated response 348 to processor 322. Furthermore, when response 348 indicates electronic device 110-1 accessed a location associated with the provider of the product or the service, accepted an offer associated with the provider of the product or the service, or purchased the product or the service, processor 322 may instruct 350 interface circuit 320 to provide a credit 352 to computer system 138 that manages an account associated with the unique verified individual. In response to receiving credit 352, computer system 138 may apply credit 352 to the account of the unique verified individual.

While FIG. 3 illustrates communication between components using unidirectional or bidirectional communication with lines having single arrows or double arrows, in general the communication in a given operation in this figure may involve unidirectional or bidirectional communication. Moreover, while FIG. 3 illustrates operations being performed sequentially or at different times, in other embodiments at least some of these operations may, at least in part, be performed concurrently or in parallel.

In some embodiments of the advertising techniques, a user may provide information to a KYC verification service, including one or more of: an identifier of the user (which may include visual confirmation, such as a photograph of the user, e.g., a driver's license or passport), location, marital status, income, age, gender, education, job title, dream job, hobbies, current car, next or future car, dream car, current watch, next or future watch, dream watch, current sound system, next or future sound system, dream sound system, planned purchases in the next 6 or 12 months, other aspirations, etc.

Moreover, personal identifiable information (PII) and authentication, the user may have an opaque key on a computer system (such as computer system 130 or 134 in FIG. 1) that is associated with their KYC values via one-way encryption (or a hash) of their PII. Therefore, once registered, the operator of the computer system will not be able to look up the PII with a user identifier. Instead, the operator of the computer system will only be able to look up a user identifier with PII (such as a password, security question answers, etc.). The exception may be the user contact information (such as their email address or cellular telephone number), which may be used for two-factor authentication.

Furthermore, regarding interests/targetable attributes, these may be associated with the opaque user identifier and may be stored securely. An authorized user may be able to view, update and/or change their interests.

Note that the association of interest categories and demographics for the purposes of targeting may occur via an intermediary identifier. When a user of a certain age, gender and location expresses an interest, e.g., in watches, this interest may be stored with their data (so the user can view, update and/or change it, as needed).

The advertising techniques may also store a targeting key that is cryptographically generated based at least in part on a universal unique identifier (UUID) and the advertising targeting specification (which may also have a second UUID). In this way, advertisements matching this specification may need to be queried with the intermediary identifier in order to be presented on a user's electronic device(s). Data and actions taken by the user (such as clicking on an advertisement, converting or purchasing a product in response to the advertisement, and/or viewing an advertisement or product) may be pushed by the user account into the system using the intermediary identifier. This means that it may be impossible to identify users from an advertisement target specification, even if the specification is made so specific that there is only one user targeted.

Unlike many other approaches, the disclosed advertising techniques may be able to report one-to-one on online sales generated by digital advertisements (even when cookies are not used).

In other approaches, user privacy may be protected by continuously limiting the targeting capabilities for advertisers. This may inflate the cost per milles (CPMs) and may necessitate the use of machine learning or artificial intelligence targeting to identify relevant users for each and every advertiser. However, these approaches are stochastic in nature and may not have the same targeting or accuracy that is available in the disclosed advertising techniques.

We now describe embodiments of an electronic device, which may perform at least some of the operations in the advertising techniques. FIG. 4 presents a block diagram illustrating an example of an electronic device 400, e.g., the electronic device, the computer, or another computer or server in the computer system, in accordance with some embodiments. For example, electronic device 400 may include: processing subsystem 410, memory subsystem 412, and networking subsystem 414. Processing subsystem 410 includes one or more devices configured to perform computational operations. For example, processing subsystem 410 can include one or more microprocessors, ASICs, microcontrollers, programmable-logic devices, GPUs and/or one or more DSPs. Note that a given component in processing subsystem 410 are sometimes referred to as a ‘computation device’.

Memory subsystem 412 includes one or more devices for storing data and/or instructions for processing subsystem 410 and networking subsystem 414. For example, memory subsystem 412 can include dynamic random access memory (DRAM), static random access memory (SRAM), and/or other types of memory. In some embodiments, instructions for processing subsystem 410 in memory subsystem 412 include: program instructions or sets of instructions (such as program instructions 422 or operating system 424), which may be executed by processing subsystem 410. Note that the one or more computer programs or program instructions may constitute a computer-program mechanism. Moreover, instructions in the various program instructions in memory subsystem 412 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 410.

In addition, memory subsystem 412 can include mechanisms for controlling access to the memory. In some embodiments, memory subsystem 412 includes a memory hierarchy that comprises one or more caches coupled to a memory in electronic device 400. In some of these embodiments, one or more of the caches is located in processing subsystem 410.

In some embodiments, memory subsystem 412 is coupled to one or more high-capacity mass-storage devices (not shown). For example, memory subsystem 412 can be coupled to a magnetic or optical drive, a solid-state drive, or another type of mass-storage device. In these embodiments, memory subsystem 412 can be used by electronic device 400 as fast-access storage for often-used data, while the mass-storage device is used to store less frequently used data.

Networking subsystem 414 includes one or more devices configured to couple to and communicate on a wired and/or wireless network (i.e., to perform network operations), including: control logic 416, an interface circuit 418 and one or more antennas 420 (or antenna elements). (While FIG. 4 includes one or more antennas 420, in some embodiments electronic device 400 includes one or more nodes, such as antenna nodes 408, e.g., a metal pad or a connector, which can be coupled to the one or more antennas 420, or nodes 406, which can be coupled to a wired or optical connection or link. Thus, electronic device 400 may or may not include the one or more antennas 420. Note that the one or more nodes 406 and/or antenna nodes 408 may constitute input(s) to and/or output(s) from electronic device 400.) For example, networking subsystem 414 can include a Bluetooth™ networking system, a cellular networking system (e.g., a 3G/4G/5G network such as UMTS, LTE, etc.), a USB networking system, a networking system based on the standards described in IEEE 802.11 (e.g., a Wi-Fi® networking system), an Ethernet networking system, and/or another networking system.

Networking subsystem 414 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between electronic devices does not yet exist. Therefore, electronic device 400 may use the mechanisms in networking subsystem 414 for performing simple wireless communication between electronic devices, e.g., transmitting advertising or beacon frames and/or scanning for advertising frames transmitted by other electronic devices.

Within electronic device 400, processing subsystem 410, memory subsystem 412, and networking subsystem 414 are coupled together using bus 428. Bus 428 may include an electrical, optical, and/or electro-optical connection that the subsystems can use to communicate commands and data among one another. Although only one bus 428 is shown for clarity, different embodiments can include a different number or configuration of electrical, optical, and/or electro-optical connections among the subsystems.

In some embodiments, electronic device 400 includes a display subsystem 426 for displaying information on a display, which may include a display driver and the display, such as a liquid-crystal display, a multi-touch touchscreen, etc. Moreover, electronic device 400 may include a user-interface subsystem 430, such as: a mouse, a keyboard, a trackpad, a stylus, a voice-recognition interface, and/or another human-machine interface.

Electronic device 400 can be (or can be included in) any electronic device with at least one network interface. For example, electronic device 400 can be (or can be included in): a desktop computer, a laptop computer, a subnotebook/netbook, a server, a supercomputer, a tablet computer, a smartphone, a smartwatch, a cellular telephone, a consumer-electronic device, a portable computing device, communication equipment, a monitoring device and/or another electronic device.

Although specific components are used to describe electronic device 400, in alternative embodiments, different components and/or subsystems may be present in electronic device 400. For example, electronic device 400 may include one or more additional processing subsystems, memory subsystems, networking subsystems, and/or display subsystems. Additionally, one or more of the subsystems may not be present in electronic device 400. Moreover, in some embodiments, electronic device 400 may include one or more additional subsystems that are not shown in FIG. 4. Also, although separate subsystems are shown in FIG. 4, in some embodiments some or all of a given subsystem or component can be integrated into one or more of the other subsystems or component(s) in electronic device 400. For example, in some embodiments program instructions 422 are included in operating system 424 and/or control logic 416 is included in interface circuit 418.

Moreover, the circuits and components in electronic device 400 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement some or all of the functionality of networking subsystem 414 and/or electronic device 400. The integrated circuit may include hardware and/or software mechanisms that are used for transmitting signals from electronic device 400 and receiving signals at electronic device 400 from other electronic devices. Aside from the mechanisms herein described, radios are generally known in the art and hence are not described in detail. In general, networking subsystem 414 and/or the integrated circuit may include one or more radios.

In some embodiments, an output of a process for designing the integrated circuit, or a portion of the integrated circuit, which includes one or more of the circuits described herein may be a computer-readable medium such as, for example, a magnetic tape or an optical or magnetic disk or solid state disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the advertising techniques may be implemented using program instructions 422, operating system 424 (such as a driver for interface circuit 418) or in firmware in interface circuit 418. Thus, the advertising techniques may be implemented at runtime of program instructions 422. Alternatively or additionally, at least some of the operations in the advertising techniques may be implemented in a physical layer, such as hardware in interface circuit 418.

In the preceding description, we refer to ‘some embodiments’. Note that ‘some embodiments’ describes a subset of all of the possible embodiments, but does not always specify the same subset of embodiments. Moreover, note that the numerical values provided are intended as illustrations of the advertising techniques. In other embodiments, the numerical values can be modified or changed.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer system, comprising:
an interface circuit configured to communicate with an electronic device and a computer;
a processor coupled to the interface circuit; and
memory, coupled to the processor, storing program instructions, wherein, when executed by the processor, the program instructions cause the computer system to perform one or more operations comprising:
obtaining information specifying a unique verified individual;
determining an interest of the unique verified individual;
providing, addressed to the electronic device associated with the unique verified individual, an advertisement based at least in part on the determined interest, wherein the advertisement is intended for the unique verified individual, and wherein the advertisement is associated with a provider of a product or a service;
receiving, associated with the electronic device or the computer, a response associated with the advertisement; and
when the response indicates the electronic device accessed a location associated with the provider of the product or the service, accepted an offer associated with the provider of the product or the service, or purchased the product or the service, providing a credit to an account associated with the unique verified individual.

2. The computer system of claim 1, wherein an identity of the unique verified individual, while unknown to the computer system, is confirmed and is not associated with another individual.

3. The computer system of claim 1, wherein the obtaining comprises receiving, associated with the electronic device, the information.

4. The computer system of claim 1, wherein the determining comprises receiving, associated with a second computer, second information specifying or corresponding to the interest of the unique verified individual.

5. The computer system of claim 1, wherein the determining comprises receiving, associated with the electronic device, second information specifying or corresponding to the interest of the unique verified individual.

6. The computer system of claim 5, wherein the second information is based at least in part on selections from predefined categories of interests.

7. The computer system of claim 5, wherein the second information is based at least in part on behaviors or activities of the unique verified individual when using the electronic device.

8. The computer system of claim 1, wherein the advertisement is provided based at least in part on advertisement parameters associated with the provider of the product or the service.

9. The computer system of claim 1, wherein the computer is associated with the provider of the product or the service.

10. The computer system of claim 1, wherein the location comprises a web page or a website.

11. The computer system of claim 1, wherein the credit comprises a cryptographic token or is associated with another type of financial instrument.

12. The computer system of claim 1, wherein the account comprises a digital wallet associated with the unique verified individual.

13. The computer system of claim 1, wherein an identity of the unique verified individual remains unknown to the computer system during operations performed by the computer system.

14. The computer system of claim 1, wherein the response comprises proof of purchase of the product or the service.

15. The computer system of claim 1, wherein the credit comprises a portion of a financial value of the advertisement.

16. A non-transitory computer-readable storage medium for use in conjunction with a computer system, the computer-readable storage medium storing program instructions, wherein, when executed by the computer system, the program instructions cause the computer system to perform one or more operations comprising:
obtaining information specifying a unique verified individual;
determining an interest of the unique verified individual;
providing, addressed to the electronic device associated with the unique verified individual, an advertisement based at least in part on the determined interest, wherein the advertisement is intended for the unique verified individual, and wherein the advertisement is associated with a provider of a product or a service;
receiving, associated with the electronic device or a computer, a response associated with the advertisement; and
when the response indicates the electronic device accessed a location associated with the provider of the product or the service, accepted an offer associated with the provider of the product or the service, or purchased the product or the service, providing a credit to an account associated with the unique verified individual.

17. The computer-readable storage medium of claim 16, wherein an identity of the unique verified individual, while unknown to the computer system, is confirmed and is not associated with another individual.

18. A method for selectively providing a credit, wherein the method comprises:
by a computer system:
obtaining information specifying a unique verified individual;
determining an interest of the unique verified individual;
providing, addressed to the electronic device associated with the unique verified individual, an advertisement based at least in part on the determined interest, wherein the advertisement is intended for the unique verified individual, and wherein the advertisement is associated with a provider of a product or a service;
receiving, associated with the electronic device or a computer, a response associated with the advertisement; and
when the response indicates the electronic device accessed a location associated with the provider of the product or the service, accepted an offer associated with the provider of the product or the service, or purchased the product or the service, providing the credit to an account associated with the unique verified individual.

19. The method of claim 18, wherein an identity of the unique verified individual, while unknown to the computer system, is confirmed and is not associated with another individual.

20. The method of claim 18, wherein the response comprises proof of purchase of the product or the service.
